(19) United States
(12) Patent Application Publication
(10) Pub. No.: US 2025/0258702 A1
(43) Pub. Date: Aug. 14, 2025

(54) Machine Learning Based Optimization for Data Processing Systems

(71) Applicant: Sony Interactive Entertainment Inc,, Tokyo (JP)

(72) Inventors: Balachandar Paulraj, Antioch, CA (US); Marcos Tong Alvarez, Oakland, CA (US); Riyan Mohammed, San Diego, CA (US)

(21) Appl. No.: 18/439,618

(22) Filed: Feb. 12, 2024

(51) Int. Cl. G06F 9/48; G06F 11/34

(52) U.S. Cl. CPC G06F 9/4881; G06F 11/3409

(57) ABSTRACT

A device, system, and computer program product for computational resource optimization. The device, system or computer program comprising a data profiler configured to generate job parameters using an input data set. A resource optimizer including a machine learning model is trained with a machine learning algorithm to generate one or more data processing system configurations using the job parameters from the data profiler and provide the one or more data processing system parameters to a data processing system. A job observation module is configured to monitor a data processing job having the one or more data system processing configurations on the data processing system and provide feedback to the resource optimizer.

### FIELD OF THE DISCLOSURE

Aspects of the present disclosure relate to optimization of data processing, more specifically aspects of the present disclosure relate to optimization of data processing tasks using machine learning techniques.

### BACKGROUND OF THE DISCLOSURE

In the current era there has been an explosion in the amount of raw data sets available to be analyzed. A drawback of having a large amount of raw data is that it takes a large amount of time to analyze the data and generate meaningful conclusions from the raw data input. Data processing allows large raw data sets to be manipulated and analyzed more quickly by placing the data into a form that is more easily understandable and/or generating meaningful information about the data such as mean, median, mode, range, comparison, as well as advanced data uses such as, encoding, decoding, and machine learning techniques. Data processing may be performed on data processing systems which may be general purpose computers or specialized data processing computers. These specialized processing computers may include multi-core parallel computing environments, with specialized driver cores and executor cores. Generating a data processing job requires selection of numerous configuration settings for the data set being processed on the data processing system. The data processing system configuration controls how the data set is processed and what resources the data processing system uses with the data set. An improper data processing system configuration can cause the data set to be processed slowly, use too many costly system resources, or even fail. Thus, users seek to optimize the data processing system configuration for each particular data set.

Traditional approaches to optimizing data processing system configurations for data processing jobs can be time-consuming and inefficient. Manually fine-tuning parameters, adjusting cluster resources, and optimizing data shuffling can be complex, time consuming for the user and error prone. Manual fine-tuning parameters may also lead to sub-optimal job performance, longer execution times and increased operational costs as most users do not have a complete knowledge of how the settings in the data processing system configuration affects the execution of a data processing job. Thus, there is a need for automated solutions to optimize data processing jobs which can learn and optimize data processing system configurations for data processing tasks based on optimized historical tasks.

Previously, as discussed in Mao, Hongzi, “Deep Resource Management with Deep Learning” In ACM Workshops on Hot Topics in Networks (HotNets-XV), Dated 9 Nov. 2016, machine learning has been used in load balancing tasks. These previous techniques have not been content aware or able to determine the configuration of the data processing system for each data processing job.

It is within this context that aspects of the present disclosure arise.

### BRIEF DESCRIPTION OF THE DRAWINGS

The teachings of the present disclosure can be readily understood by considering the following detailed description in conjunction with the accompanying drawings, in which:

FIG. 1 is a block diagram showing an implementation of machine learning based optimization for a data processing system according to aspects of the present disclosure.

FIG. 2 is a block diagram depicting the job profiler in the data processing job optimization system according to aspects of the present disclosure.

FIG. 3 is a block diagram showing the operation of the resource optimizer with a machine learning model trained with a machine learning algorithm in the data processing job optimization system according to aspects of the present disclosure.

FIG. 4 is a block diagram depicting the operation of the job observer with a data processing system according to aspects of the present disclosure.

FIG. 5 is a block diagram depicting a method for training a resource optimizer machine learning model according to aspects of the present disclosure.

FIG. 6 is a block system diagram showing a system implementing computational resource optimization according to aspects of the present disclosure.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, examples of embodiments of the invention described below are set forth without any loss of generality to, and without imposing limitations upon, the claimed invention.

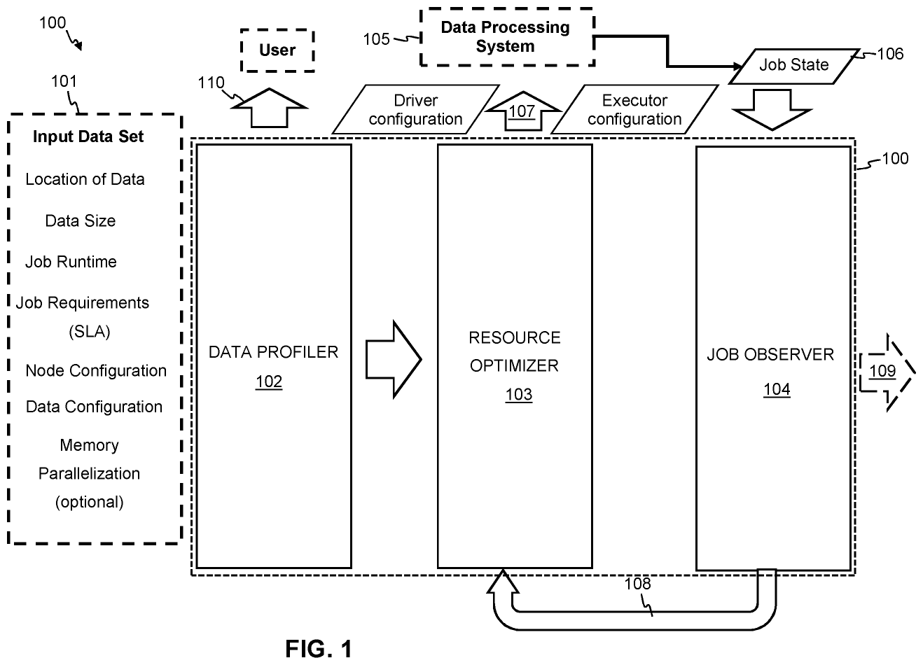

FIG. 1 is a block diagram showing an implementation of machine learning based optimization for a data processing system according to aspects of the present disclosure. As shown, a data processing system optimizer device 100 includes a data profiler 102, resource optimizer 103 and job observer 104. The data profiler may take as input an input data set 101. The input data set 101 may have job parameters associated with it. The job parameters may either be entered manually by a user to the data profiler 102 or discovered from analysis of data set metadata by the data profiler 102. The data profiler 102 may retain the set of job parameters 110 for the provisioning to the user and provide the job parameters to the resource optimizer 103. Additionally, the data profiler may generate statistics about the input data set, for example number of similar input data sets processed, similar sized data set processing times, average input data set processing times etc. These statistics may be gathered from the job fulfillment metrics provided by the job observer and/or from historical job fulfillment data. The job fulfillment metrics may include, for example and without limitation, elapsed time, time to complete, error rate, current job failure rate, data duplication level, cost of the compute resource (e.g., value of computing resources used). The job parameters may include location of the input data set, input data set size, job runtime, Job requirements (also known as Service Level Agreement adherence), Node configuration, input data set configuration, memory parallelization. The Job requirements may include the job fulfillment requirements such as, required time to complete, required error rate, required job failure rate, and required data duplication level.

The resource optimizer 103 may receive the job parameters from the job observer 104 and generate one or more data processing system configurations 107 using the job parameters and, in some implementations, from the input data set 101. Additionally, the resource optimizer 103 may receive job fulfillment metrics 106 from the job observer 104 and use the job fulfillment metrics to update the one or more data processing system configurations. Here, the job fulfillment metrics may be measures of the in-process job fulfillment based on the job fulfillment requirements, for example and without limitation: in process elapsed processing time, in process error rate, in process job failure rate, in process data duplication level and in process cost of the job on the data processing system. The resource optimizer 103 may include one or more machine learning models trained with a machine learning algorithm to generate the one or more data processing system configurations. The machine learning models may be one or more neural networks such as recurrent neural networks (RNN), convolutional neural networks (CNN), convolutional recurrent neural networks (CRNNS), Feed Forward neural network, Multilayer Perceptron neural network etc. The machine learning algorithm here may be any suitable algorithm for example and without limitation a reinforcement learning algorithm. The one or more data processing system configurations 107 may be provided to the data processing system 105 and the data processing system may be configured to use the data processing system configuration on a data processing job where the data processing job is operating on the input data set 101.

Here, the data processing system 105 may be any suitable system that may perform data processing jobs, for example the data processing system may be running locally on the same computer system as the job optimizer or may be on a remote server connected with the job optimizer over a network. The data processing system 105 may include a cluster computing architecture with a driver system and multiple executor systems. In some implementations several groupings of driver systems and executor systems may be used. The driver system may orchestrate the operation of the one or more executor systems. As such the job optimizer may generate one or more driver configurations and one or more executor configurations as part of the data processing system configurations 107. The data processing system 105 may apply the data process system configurations 107 to an input data set and/or processing job.

During processing, the data processing system 105 may be generate one or more reports on the job processing state that are sent to the job observer 104. Alternatively, the data processing system may present one or more interfaces through which the job observer 104 may monitor the processing job state 106. The job observer 104 may interpret the job processing job state to generate job fulfillment metrics. For example, and without limitation, the job observer may format the job processing state data into the format of the in-process job fulfillment metrics. Additionally, the job observation module may optionally provide job information 109 to the user, such as visualization of the in-process job fulfillment metrics and maintain historical information of the job fulfillment metrics and changes made with the one or more data processing system configurations for (optional) provision to the user. As discussed above the job observation module provides in process job fulfillment metrics 106 to the resource optimizer for refinement of the one or more data processing configurations.

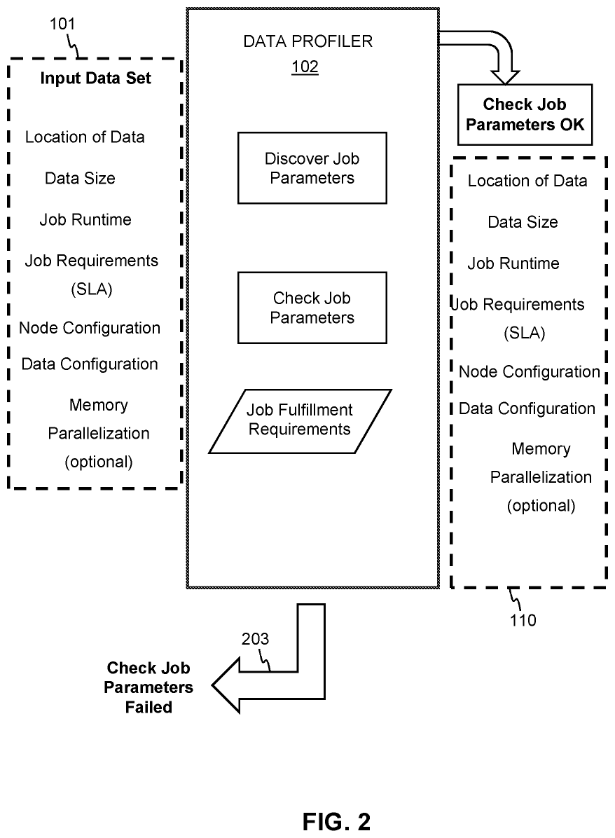

FIG. 2 is a block diagram depicting an example of a job profiler in a data processing job optimization system according to aspects of the present disclosure. Here the job profiler 102 may be implemented as a specialized processing module in hardware through hardware logic or in a specialized integrated circuit such as an Application Specific Integrated circuit (ASIC) or field programmable gate array (FPGA) with specific hardware programming for the job profiler. Alternatively, the job profiler 101 may be implemented in software in a general-purpose computing system. In some implementations the job profiler may also include one or more processors specialized for machine learning, (neural processors). The job profiler 102 takes as input an input data set 102 and may additionally receive one or more job parameters from a user. In some implementations the job profiler 102 may discover one or more of the job parameters from analysis of the metadata of the input data set 101 The data profiler may discover job parameters by for example and without limitation, examining the size of input data set, examining the format of the input data set (e.g. data file type, number of columns and rows), examining number of entries in the input data set, examining the location of the input data set (e.g., whether the file is located on the data processor or on another system). Job parameters such as job requirements may be taken from the user. As discussed above, the job parameters may include location of the input data set, input data set size, job runtime, job requirements (also known as Service Level Agreement adherence (SLA)), Node configuration, input data set configuration, memory parallelization. The Job requirements may include the job fulfillment requirements such as, required time to complete, required error rate, required job failure rate, and required data duplication level.

The data profiler may also check the input data set for errors that may cause processing to fail. For example, and without limitation, the data profiler may check the input dataset for invalid values, missing values, inconsistent formatting, job parameter conflicts, incompatible parameter values, data type related changes etc. Should an error be detected the data profiler 201 may send a notification 203 to the user indicating that the input data set failed the initial error checking procedure.

Additionally, in some implementations the job profiler 102 may be configured as an expert system with sufficient programing to provide statistics about the input data set 101, for example number of similar input data sets processed, similar sized data set processing times, average input data set processing times etc. Alternatively, the job profiler 102 may include a machine learning model trained with a machine learning algorithm, such as a convolutional neural network (CNN), to predict statistics about the input data set for example number of similar input data sets processed, similar sized data set processing times, average input data set processing times etc. The machine learning model may be trained with historical job fulfillment information.

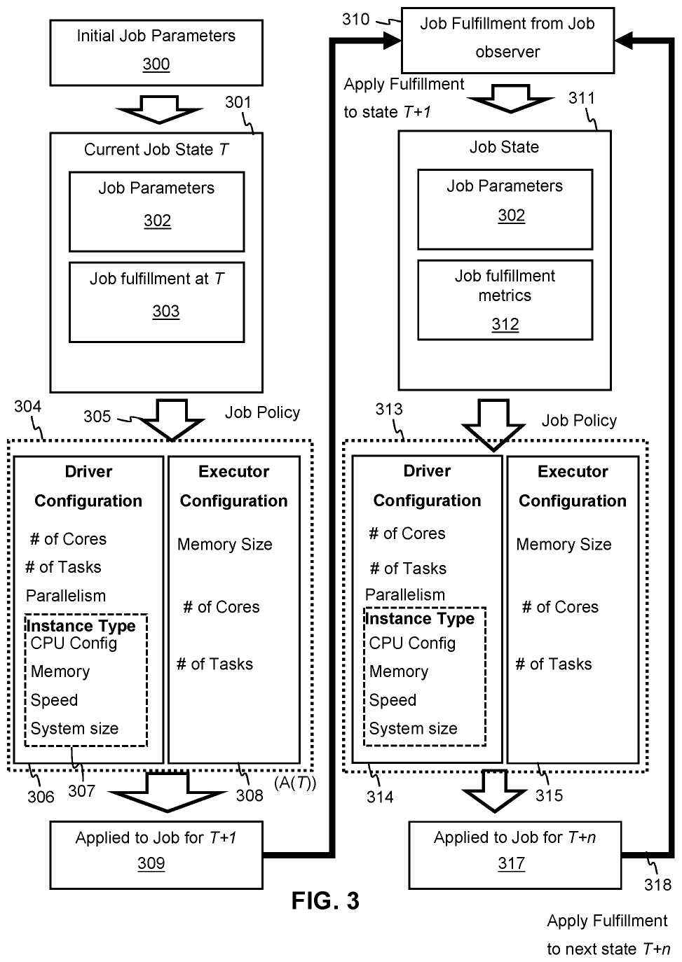

FIG. 3 is a block diagram showing the operation of the resource optimizer with a machine learning model trained with a machine learning algorithm. Initially job parameters 300 may be received from the job profiler, here the job parameters may, in some implementations, include the input data set. As discussed above the job parameters include location of the input data set, input data set size, job runtime, job requirements (also known as Service Level Agreement adherence), node configuration, input data set configuration, memory parallelization. The Job requirements may include the job fulfillment requirements such as, required time to complete, required error rate, required job failure rate, and required data duplication level. Each of the job parameters 302 may be taken as feature vectors for the input to a resource optimization machine learning model and represented in the current state information 301 for the machine learning model. The machine learning model for the resource optimizer may be a neural network, for example and without limitation a convolutional neural network. The neural network may include any number of network layers, for example fully connected, convolutional, soft max etc. The window of the convolutional neural network may be chosen to optimize the prediction of data processing system configuration parameters. The machine learning algorithm shown here used with machine learning model is a reinforcement learning type algorithm. The current state 301 also includes representations of the current job fulfillment metrics at the current time T as indicated at 303. In the diagram shown the model was executed at time T and therefore the job fulfillment metrics 303 may represent an initial state of the job process. Additionally, in some implementations the job fulfillment metrics 303 may include initial data processing system configurations. These initial data processing system configurations may be randomized for the initialization step. From the state information 301 the job optimizer may use the trained machine learning model to predict at 305 the data processing system configurations 304 for the next time step as an action (A(T)) taken in the reinforcement learning algorithm. These optimal data processing system configurations 304 may be predicted 305 in accordance with a policy optimized during training, e.g., with a policy-based reinforcement learning (RL) method.

As shown the predicted data processing system configuration 304 may include one or more driver configurations 306 and one or more executor configurations 308. The driver configuration 306 may include settings required by the data processing systems to run the data processing job and any additional setting that may increase the efficiency of fulfillment of the data processing job. Some example driver configuration settings in the driver configuration are, without limitation, number of driver cores, number of driver tasks, parallel tasks (parallelism), (optionally) instance type 307. Instance type 307 may define the type of computing device or devices running the driver and executor systems. The instance type settings may include for example and without limitation CPU configuration (e.g. CPU core count, CPU architecture etc.), Memory size, Speed (e.g. CPU clock speed (i.e. CPU Speed), memory speed etc.), system size (e.g. how many executor units per system etc.). The executor configuration settings 308 may include settings required by the data processing systems to run the data processing job and any additional setting that may increase the efficiency of fulfillment of the data processing job. The executor settings may include for example and without limitation, size of the executor memory, number of executor cores, number of executor tasks, etc.

After generation, the data processing system configurations 304 may be applied to the data processing system for processing at the next time step T+1, as indicated at 309. As discussed above the data processing system may be a remote data processing server and in which case the data processing system configurations may be sent over the network to the remote data processing servers.

The data processing system then begins carrying out the data processing job in the configuration dictated by the data processing configurations for a time step. In the next time step T+1 the job observer monitors the job state and generates job fulfillment metrics 310 from the job state. The job fulfillment metrics 310 are then provided to the resource optimizer and applied to the job state 311 for the next time step T+1. The Job state for time step T+1 may include the Job parameters 302 passed from the previous job state at T and the updated job fulfillment metrics 312. Additionally, in some implementations the job fulfillment metrics 312 in the job state for time step T+1 may include the data processing system configuration applied for time step T+1. As with the previous time step, the job state is taken as input to the trained resource optimizer machine learning model. The machine learning model may then predict data processing system configurations 313 for the next time step T+n in accordance with the job policy. As with the previous time step, in this time step the resource optimizer may predict driver configuration 314 and executor configuration 315 as the action (A(T+1)) taken by the machine learning model at time step T+1. The data processing configuration is then applied to the data processing job running on the data processing server for the next time step T+n, as indicated at 317. The process then repeats with the Job Observer monitoring the data processing Job and generating the job fulfillment metrics 310 for T+n. It should be understood that the Resource Optimizer may be implemented as a software module running on a computer or as a hardware module formed with hardware logic or on an ASIC or programmed FPGA.

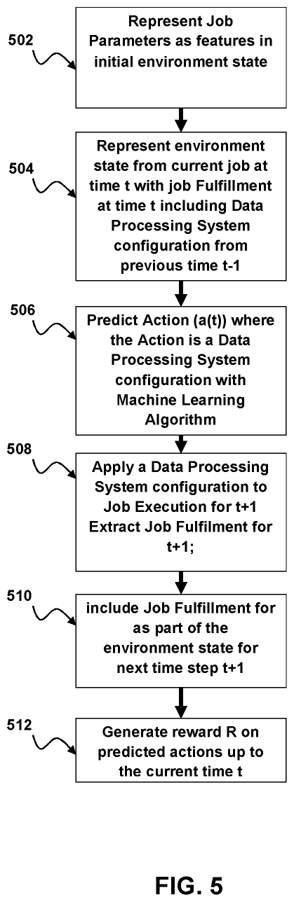

Training of the machine learning model for the job optimizer is similar to execution of the trained model but with the addition of a reward function and training of machine learning model weights and biases. FIG. 5 is a block diagram depicting a method for training a resource optimizer machine learning model according to aspects of the present disclosure. Here, training a reinforcement learning type machine learning model algorithm is shown. Reinforcement learning models an agent taking an action at based on an environment state sₜ₊ₙ an environment space S. The effect of the action on the environment is measured and a reward rₜ is provided using the environment state after the action according to a reward function R (s, a). In a typical reinforcement learning scheme the agent predicts the action at from an action space A based on a policy π(aₜ|Sₜ) which maps the action to the environment state. After the action is taken, the process continues for another action decision at the next time step t+1. The environment state further updated after the action to produced sₜ₊₁. For data processing this optimization process continues till the data processing job is completed. In some implementations the reward may include a discount function which reduces accumulated reward for each subsequent state provided by the equation Σₙ₌₀^{∞}γⁿrₜ+n with the discount factor γ between 0 and 1.

In some implementations, the training may utilize a reinforcement learning algorithm that includes a policy to optimize at least cost based on runtime constraints.

As shown in FIG. 5, the environment state sₜ here takes as features the job parameters at 502 generated by the job profiler. The environment state sₜ is further provided with job fulfillment metrics for the current job process at 504, which at initialization will be in an initial state (e.g., zero). The current job fulfillment metrics may also include the previous iteration's data processing system configuration. At the initial state, the data processing system configuration may be randomized.

The machine learning model predicts action aₜ based on the policy π(aₜ|Sₜ) where the action at includes one or more data processing system configurations at 506. Here the data processing system configuration settings are represented as an action in the action space and in some implementations each data processing system configuration setting may be chosen by the machine learning model.

During training, the one or more data processing system configurations are applied to a simulated data processing job whose optimal configuration is already known, as indicated at 508. The job fulfillment metrics of the simulated data processing job are extracted from the current time step of the simulated data processing job.

The environment state Sₜ is then updated with the job fulfillment metrics to generate the environment state for the next time step Sₜ₊₁ at 510. The reward R is generated for all predicted actions up to the current time step using the using the job fulfillment metrics at 512 and the machine learning model is then trained using the reward. Training may be performed using any suitable neural network training algorithm, for example back propagation with stochastic gradient descent. As discussed above the job fulfillment metrics may include for example and without limitation, elapsed time, estimated additional time to complete, error rate, current job failure rate, data duplication level, estimated cost of the computing resources. The reward function generating the reward may be any suitable function that generates a reward value based on the job fulfillment metrics. In some implementations the reward function may compare the job fulfilment metrics to historical optimized job fulfillment metrics. In some implementations the reward function may generate a reward value based on comparison of the job fulfillment metrics to the job fulfillment requirements generated by the job profiler. Alternatively, the reward function may seek to minimize or maximize one or more of the job fulfillment metrics. For example, and without limitation, the reward function may reward minimizing one or more of, cost of the computing resources, processing time (job runtime constraints), error rate, failure rate, data duplication. After training with the reward function, the process may start again, as indicated at 504, starting with the next environment state Sₜ₊₁. This method may continue until the processing task finishes and training may continue until the policy accurately predicts the configuration parameters similar to the optimized historical configuration parameters and/or there are further changes to job fulfillment metrics after many iterations.

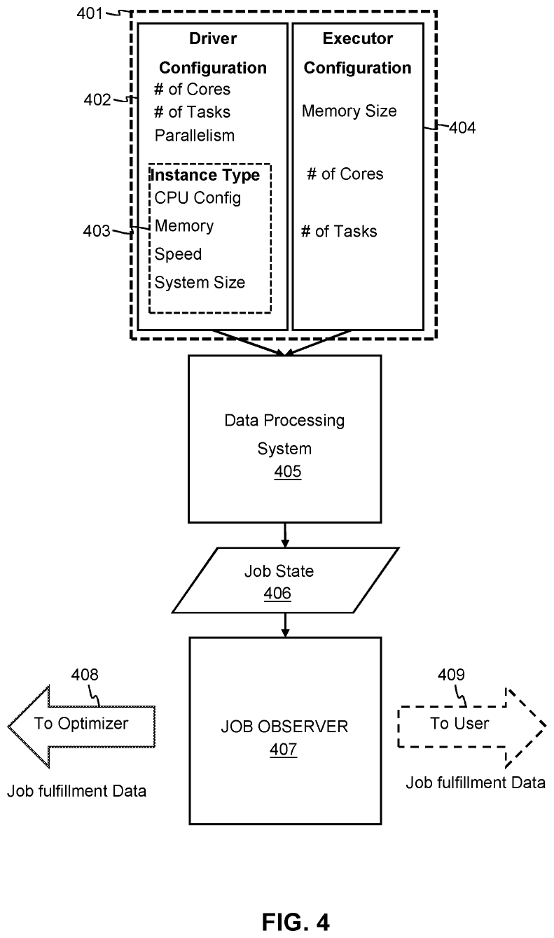

FIG. 4 is a block diagram depicting the operation of the job observer 104 with a data processing system 405 according to aspects of the present disclosure. As shown, one or more data processing system configurations 401 are provided to the data processing system 405. As discussed above, the one or more data processing system configurations may be files that instruct how a data processing job should be carried out on the data processing system 405. The data processing system configuration 401 may include one or more driver configurations 402 and one or more executor configurations 404. The driver configuration 402 may include settings required by the data processing systems to run the data processing job and any additional setting that may increase the efficiency of fulfillment of the data processing job. Some example driver configuration settings in the driver configuration are, without limitation, number of driver cores, number of driver tasks, parallel tasks, and (optionally) instance type 403. The instance type may define the type of computing device or devices running the driver and executor systems the instance type settings may include for example and without limitation CPU configuration (e.g. CPU core count, CPU architecture etc.), Memory size, Speed (e.g. CPU clock speed, memory speed etc.), system size (e.g. how many executor units per driver etc.), number of virtual CPU, instance storage, etc. The executor configuration settings 404 may include settings required by the data processing systems to run the data processing job and any additional setting that may increase the efficiency of fulfillment of the data processing job. The executor settings may include for example and without limitation, size of the executor memory, number of executor cores, number of executor tasks, etc.

The data processing system 405 may be on the same computing system as the computational resource optimization system 100 or may be located in a remote location and connected to the computational resource optimization system over a network. In either case the data processing system 405 receives the one or more data processing system configurations and is configured to implement a data processing job using the settings in the one or more data processing system configurations.

During processing, the data processing system 405 may make job state information 406 available to the job observer 407. By way of example and not by way of limitation, the data processing system may provide one or more listening nodes that are accessible to the job observer. These listening nodes may allow the job observer to passively receive information about the state of the job being processed on the data processing system and extract the job state from that information. Such job state information may include, for example, resource utilization, task completion time, memory allocation, parallelism and the like. Alternatively, the data processing system may be configured to periodically push job state information to the job observer. For example, the data processing system may send job state information over a network or data bus to the job observer.

From the job state information 406 the job observer 407 may generate one or more of the job fulfillment metrics. For example, and without limitation, the job observer may directly receive from the data processing server the number of errors and/or number of data duplicates generated for the current job. Similarly, the job observer 407 may receive a number of job failures or the job failure rate. The job observer may maintain a running log of the number of job errors and/or job failure rate for the job fulfillment metrics The data processing system 405 may provide the progress on the job to the job observer for example and without limitation the data processing system may provide the size of the data processed and the size of the data not yet processed e.g. number of rows and/or columns processed, number of bytes processed, number of tasks completed etc. In another example implementation, the job observer may generate fulfillment metrics such as the cost of data processing, for example and without limitation the job observer may maintain and internal data base containing the cost of services from the data processing system. The job observer may calculate the number of services used up to the current time point of the job with the cost of those services. The definition of services and pricing of services varies by the provider of the data processing system 405 but generally these services are priced based on the configuration of the data processing system for example, the number of nodes in the system, size of the Memory of the system, the clock speed of the processors in the data processing system, the clock speed of the memory in the data processing system, etc.

The job observer may maintain records of the job fulfillment metrics for each job allowing job fulfillment metrics and/or job state information to be provided to the user 409 upon request. The job fulfillment metrics and/or job state information may be sent to a display and displayed on a display screen for viewing by a user. Additionally, the job observer provides feedback job fulfillment metrics to the resource optimizer 408. As discussed above the resource optimizer may use the job fulfillment metrics with a machine learning model to generate one or more data processing configurations. It should be understood that the job observer 407 may be implemented as a software module running on a computer or as a hardware module formed with hardware logic or on an ASIC or programmed FPGA.

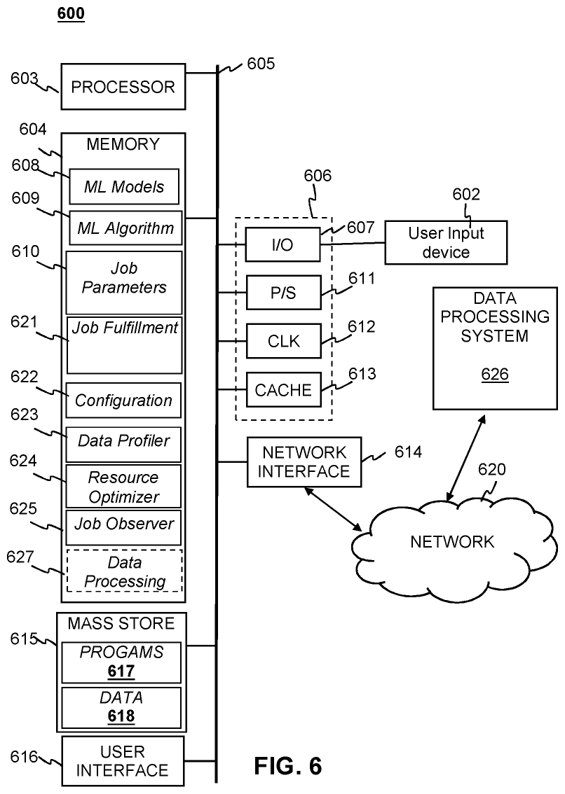

FIG. 6 is a block system diagram showing a system implementing computational resource optimization according to aspects of the present disclosure. The system may include a computing device 600 coupled to a user input device 602. The user input device 602 may be a controller, touch screen, keyboard, mouse, joystick, motion control device, e.g., an inertial measurement unit (IMU), microphone or other device that allows the user to input speech data into the system.

The computing device 600 may include one or more processor units 603, which may be configured according to well-known architectures, such as, e.g., single-core, dual-core, quad-core, multi-core, processor-coprocessor, cell processor, and the like. The computing device may also include one or more memory units 604 (e.g., random access memory (RAM), dynamic random-access memory (DRAM), read-only memory (ROM), and the like).

The processor unit 603 may execute one or more programs, portions of which may be stored in the memory 604 and the processor 603 may be operatively coupled to the memory, e.g., by accessing the memory via a data bus 605. The programs may be configured to implement machine learning models (e.g., computer neural networks) for the resource optimizer module and/or the job profiler module 608. The training for the machine learning models may be carried out using one or more machine learning algorithms 609 such as the algorithm shown in FIG. 5 stored in the memory. The Memory 604 may also contain software modules such as a Data profiler Module 623, Resource Optimizer Module 624, and/or Job observer Module 624. The Data Profiler Module may generate Job parameters 610 from an input data set as discussed above. The Resource Optimizer Module may generate one or more data processing system configuration files 622 by, for example, the method shown in FIG. 3 and stored in the memory 604. The Job observer module may generate job fulfillment metrics 621 stored in the memory as discussed with respect to FIG. 4. In some optional implementations data processing programs 627 may be stored in the memory and carry out data processing tasks on input data sets according to the data processing configuration 622. The overall structure and probabilities of the NNs may also be stored as data 618 in the Mass Store 615. The processor unit 603 is further configured to execute one or more programs 617 stored in the mass store 615 or in memory 604 which cause processor to carry out the method of training machine learning models 608 for the resource optimizer and/or data profiler. The system may generate Neural Networks as part of the NN training process. Completed NNs may be stored in memory 604 or as data 618 in the mass store 615.

The computing device 600 may also include well-known support circuits, such as input/output (I/O) elements 607, power supplies (P/S) 611, a clock (CLK) 612, and cache 613, which may communicate with other components of the system, e.g., via the data bus 605. The computing device may include a network interface 614. The processor unit 603 and network interface 614 may be configured to implement a local area network (LAN) or personal area network (PAN), via a suitable network protocol, e.g., Bluetooth, for a PAN.

The computing device may optionally include a mass storage device 615 such as a disk drive, CD-ROM drive, tape drive, flash memory, or the like, and the mass storage device may store programs and/or data. The computing device may also include a user interface 616 to facilitate interaction between the system and a user. The user interface may include a display device, e.g., a monitor, flat screen, or other audio-visual device.

The network interface 614 facilitates communication with an optional data processing system 626 via an electronic communications network 620. The network interface 614 may be configured to implement wired or wireless communication over local area networks and wide area networks such as the Internet. The device 600 may send and receive data and/or requests for files via one or more message packets over the network 620. Message packets sent over the network 620 may temporarily be stored in a buffer in memory 604.

As may be seen from the foregoing discussion, a computational resource optimization device, system or computer program product may be created that generates optimized data processing system configurations and monitors progress of data processing jobs ensuring efficient completion of said jobs. This is an improvement over prior methods of generation of data processing system configurations as they relied on research, trial and error from data scientists to generate configuration. Thus, prior methods of data processing system configuration generation were slow whereas the present disclosure accelerates and automates the process of data processing system configuration generation with machine learning techniques. Additionally, the present disclosure provides for dynamic parameter adjustment as the job observation module monitors the job and provides feedback to the resource optimizer which may change the data processing systems configuration during processing. The resource optimizer further optimizes data shuffling to analyze data shuffling patterns and minimize data transfer, e.g., by executing the same job multiple times with different configurations including, but not limited to memory configurations, job configurations, etc.

While the above is a complete description of the preferred embodiment of the present invention, it is possible to use various alternatives, modifications, and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A,” or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A device for computational resource optimization, comprising:
a data profiler configured to generate job parameters using an input data set;
a resource optimizer including a machine learning model trained with a machine learning algorithm to generate one or more data processing system configurations using the job parameters from the data profiler and provide the one or more data processing system parameters to a data processing system; and
a job observation module configured to monitor a data processing job having the one or more data system processing configurations on the data processing system and provide feedback to the resource optimizer.

2. The device of claim 1 wherein the job parameters include one or more in the list consisting of data location, data size, estimated job runtime, job requirements, node configuration, data configuration, estimated memory parallelization.

3. The device of claim 1 wherein the device profiler includes a machine learning model trained with a machine learning algorithm to estimate one or more job fulfillment metrics.

4. The device of claim 1 wherein the data profiler is further configured to check the input data set for one or more of missing values, null values, and incompatible values.

5. The device of claim 1 wherein the machine learning model includes a convolutional neural network.

6. The device of claim 1 wherein the machine learning algorithm includes a reinforcement learning algorithm.

7. The device of claim 6 wherein the reinforcement learning algorithm includes a policy to optimize at least cost based on runtime constraints.

8. The device of claim 6 wherein the resource optimizer is further configured to use one or more job fulfillment metrics as state information with the reinforcement learning algorithm.

9. The device of claim 6 wherein the resource optimizer is configured to use the one or more job parameters as state information with the reinforcement learning algorithm.

10. The device of claim 1 wherein the one or more data processing system configurations includes a driver system configuration and one or more executor system configurations.

11. The device of claim 10 wherein the driver system configuration includes one or more from the list consisting of number of cores, number of tasks, parallelism, and instance type.

12. The device of claim 11 wherein instance type includes one or more of CPU configuration, Memory size, CPU Speed, Memory Speed, or system size.

13. The device of claim 10 wherein the executor system configuration includes one or more from the list consisting of memory size, memory speed, number of executor cores, and number of executor tasks.

14. The device of claim 1 wherein the job observer is configured to receive job state information from the one or more data processing systems and generates one or more job fulfillment metrics from the job state information.

15. The device of claim 14 wherein the feedback provided by the job observer to the resource optimizer includes one or more the job fulfillment metrics.

16. The device of claim 14 wherein the job observer is further configured to provide the job state information to a display screen and the display screen is configured to display the job state information to a user.

17. The device of claim 1 wherein the one or more data processing system configurations is sent over a network to the data processing system and wherein the job observer receives the job state information from the data processing system over the network.

18. A system for computational resource optimization, comprising;
a processor;
a memory communicatively coupled with the processor;
non-transitory instructions embodied in the memory that when executed by the processor cause the system to carry out a method for computation resource optimization, the method comprising;
generating job parameters using an input data set;
generating one or more data processing system configurations using the job parameters from the data profiler with machine learning model trained with a machine learning algorithm and providing the one or more data processing system parameters to a data processing system; and
monitoring a data processing job having the one or more data system processing configurations on the data processing system and provide feedback to the resource optimizer.

19. A non-transitory computer readable medium have executable instruction embodied therein, that when executed cause a computer to carry out a method for computational resource optimization, the method comprising:
generating job parameters using an input data set;
generating one or more data processing system configurations using the job parameters from the data profiler with machine learning model trained with a machine learning algorithm and providing the one or more data processing system parameters to a data processing system; and
monitoring a data processing job having the one or more data system processing configurations on the data processing system and provide feedback to the resource optimizer.
